(19) United States
(12) Patent Application Publication
(10) Pub. No.: US 2013/0320790 A1
(43) Pub. Date: Dec. 5, 2013

(54) VIBRATION GENERATOR

(71) Applicant: NIDEC SEIMITSU CORPORATION, Ueda-shi (JP)

(72) Inventor: Takayuki Aoi, Ueda-shi (JP)

(73) Assignee: NIDEC SEIMITSU CORPORATION, Ueda-shi (JP)

(21) Appl. No.: 13/874,728

(22) Filed: May 1, 2013

(30) Foreign Application Priority Data
May 31, 2012 (JP) 2012-125433
Jan. 8, 2013 (JP) 2013-001363

(51) Int. Cl. H02K 7/06

(52) U.S. Cl. CPC H02K 7/063
USPC 310/81

(57) ABSTRACT

A vibration generator includes a rotary unit configured to rotate, a weight arranged to generate a vibration in the rotary unit and an electromagnet arranged to displace the weight to a position where a vibration is generated in the rotary unit. The electromagnet is configured to generate an eccentric load in the rotary unit by displacing the weight with an electromagnetic force generated when an input signal is sent to the electromagnet.

### BACKGROUND OF THE INVENTION

1. Field of the Invention

The present invention relates to a vibration generator. Moreover, the present invention pertains to a vibration generator in which vibration is generated by displacing a weight and eventually destroying the weight balance of a rotary unit.

2. Description of the Related Art

A tablet such as a tablet PC or a pen tablet includes an input means, e.g., a touch panel, for creating different functions by allowing a finger or a pen to make contact with a surface thereof. A game console or a navigation system is also provided with a similar input means. A display device such as a tablet or a navigation system includes a notification means for notifying an operator of an input operation by, e.g., generating a sound or a vibration when the input operation is performed by the input means.

As one example of the notification means, there are proposed many different vibration generators for generating a vibration when a cellular phone receives an incoming call. JP2003-333773A discloses a vibration generator in which an eccentric weight is added to a rotating shaft of a small-size motor. JP2000-50566A discloses a vibration generator in which a strong sensory vibration is applied to a user by vertically moving or forwardly and reversely rotating a rotationally-vibrating weight about a post. The vibration generator disclosed in JP2003-333773A or JP2000-50566A is primarily mounted to a cellular phone and is operated by an incoming call signal, thereby generating a vibration.

JP2006-304498A discloses a technology in which a vibration motor for generating a vibration upon receiving an incoming call in a manner mode and a zoom lens drive motor for a digital camera are used in common to reduce the number of parts. In this technology, when an incoming call is not received, an eccentric weight axially movably attached to a motor shaft in a non-rotatable condition is clutch-coupled to a zoom lens low speed drive mechanism, thus establishing a torque delivery mode in which a vibration is not noticeable. On the other hand, when an incoming call is received, the clutch coupling between the eccentric weight and the zoom lens low speed drive mechanism is released by an electric current supplied during reception of the incoming call. The motor is rotated at a high speed by an electric current supplied subsequently, thus establishing a vibration mode in which the eccentric weight is allowed to follow the high speed rotation of the motor to thereby generate a specified vibration.

In the technology disclosed in JP2003-333773A or JP2000-50566A, the vibration motor is rotated and driven after reception of an incoming call. For that reason, there is posed a problem in that a time lag is likely to occur until the generation of a vibration. In the technology disclosed in JP2006-304498A, the clutch coupling of the weight is released by an electric current supplied during reception of the incoming call. Then, the weight is vibrated by rotating the motor at a high speed with an electric current supplied thereafter. Therefore, there is posed a problem in that a time lag is likely to occur until the generation of a vibration.

In a display device such as a tablet PC, a pen tablet, a game console or a navigation system, unlike the reception of an incoming call in a cellular phone, input operations are continuously performed on the surface of the display device. For that reason, in the technologies of JP2003-333773A, JP2000-50566A and JP2006-304498A in which a motor is driven after the signal of an incoming call is inputted, there is a problem in that a functional response delay or a sensory response delay occurs.

### SUMMARY OF THE INVENTION

In view of the above, the present invention provides a vibration generator capable of rapidly generating a sensory vibration during an input operation.

In accordance with an aspect of the present invention, there is provided a vibration generator including a rotary unit configured to rotate, a weight arranged to generate a vibration in the rotary unit, and an electromagnet arranged to displace the weight to a position where a vibration is generated in the rotary unit. The electromagnet is configured to generate an eccentric load in the rotary unit by displacing the weight with an electromagnetic force generated when an input signal is sent to the electromagnet.

With such configuration, the electromagnetic force generated when the input signal is sent to the electromagnet displaces the weight to a position where a vibration is generated in the rotary unit. It is therefore possible to generate a vibration in the rotary unit by the action of the weight thus displaced. For that reason, even if the rotary unit is rotating at all times, a vibration is generated at the moment when the weight is displaced as a result of the input signal being sent to the electromagnet. The vibration generator of the present invention can be mounted to a display device such as a tablet PC, a pen tablet, a game console or a navigation system. In this case, if an input signal is sent by performing an input operation on a display surface, a vibration is instantaneously generated in the rotary unit under rotation. It is therefore possible to rapidly generate a sensory vibration when an input operation is performed.

The vibration generator of the present invention can be largely divided into a first preferred embodiment and a second preferred embodiment.

In the vibration generator according to the first preferred embodiment of the present invention, the rotary unit, the weight and the electromagnet are separately arranged along a thrust direction in the named order. The weight is kept biased toward the electromagnet by a biasing unit. The electromagnet is configured to, upon receiving the input signal, displace the weight toward the rotary unit with an electromagnetic force stronger than a biasing force of the biasing unit and bring the weight into contact with the rotary unit. By the term “non-unitarily”, it is meant that the weight and the electromagnet do not always follow the rotation and stoppage of the rotary unit.

With such configuration, the electromagnetic force for displacing the weight toward the rotary unit after the input signal is sent to the electromagnet is stronger than the biasing force of the biasing unit for biasing the weight toward the electromagnet. Therefore, the weight is biased toward the electromagnet before the input signal is sent to the electromagnet. The weight is moved away from the electromagnet and is displaced toward the rotary unit after the input signal is sent to the electromagnet. The weight displaced to the rotary unit under rotation destroys the weight balance of the rotary unit and applies an eccentric load to the rotary unit, thereby instantaneously generating a vibration.

In the vibration generator according to a first example of the first preferred embodiment of the present invention, the weight includes magnetic portions and a non-magnetic portion, the magnetic portions arranged to generate a magnetic path in the electromagnet, the weight and the rotary unit when the input signal is sent to the electromagnet. The magnetic portions are configured to radially interpose the non-magnetic portion therebetween.

With such configuration, the magnetic portions making up the weight are arranged to radially interpose the non-magnetic portion therebetween. Thus, the magnetic portions interposing the non-magnetic portion therebetween become a portion of the magnetic path and form the magnetic path in cooperation with the electromagnet and the rotary unit. As a result, if the input signal is sent to the electromagnet, the weight is brought into contact with the rotary unit against the biasing force of the biasing unit under the action of the magnetic path, thereby destroying the weight balance of the rotary unit and instantaneously generating a vibration.

In the vibration generator according to a second example of the first preferred embodiment of the present invention, the weight includes a magnetic portion and a non-magnetic portion, the magnetic portion arranged to generate a magnetic path in the electromagnet, the weight and the rotary unit when the input signal is sent to the electromagnet. The magnetic portion is arranged radially inward of the non-magnetic portion.

With such configuration, the weight includes the non-magnetic portion and the magnetic portion arranged radially inward of the non-magnetic portion. This makes it possible to reduce the number of parts. The reduction in the number of parts leads to a decrease in the assembling steps. As a result, it is possible to reduce the price of a product and the manufacturing cost thereof. Since the weight includes the non-magnetic portion and the magnetic portion arranged radially inward of the non-magnetic portion, the movement response characteristic of the weight can be improved by making the weight lightweight.

In the vibration generator according to the second preferred embodiment of the present invention, the electromagnet and the weight are arranged along a radial direction. The weight includes a movable weight capable of moving in the radial direction and a fixed weight arranged opposite to the movable weight with respect to the center of the rotary unit. The electromagnet is configured to, upon receiving the input signal, generate an electromagnetic force for displacing the weight radially inward against a centrifugal force generated by rotation of the weight.

With such configuration, the movable weight is displaced radially outward by the centrifugal force of the rotary unit under rotation before the input signal is sent to the electromagnet. The movable weight is displaced radially inward by the electromagnetic force after the input signal is sent to the electromagnet. When displaced radially inward, the movable weight destroys the weight balance of the rotary unit and applies an eccentric load to the rotary unit, thereby instantaneously generating a vibration.

In the vibration generator according to the second preferred embodiment of the present invention, the movable weight includes a magnetic portion and non-magnetic portions, the magnetic portion arranged to generate a magnetic path in the electromagnet and the movable weight when the input signal is sent to the electromagnet, the magnetic portion arranged at the center of the movable weight.

With such configuration, the magnetic portion making up the movable weight is arranged at the center of the movable weight. Therefore, the magnetic portion becomes a portion of the magnetic path and forms the magnetic path in cooperation with the electromagnet. As a result, if the input signal is sent to the electromagnet, the movable weight is displaced radially inward against the centrifugal force under the action of the magnetic path, thereby destroying the weight balance of the rotary unit and instantaneously generating a vibration.

In the vibration generator of the present invention, the electromagnetic force generated by sending the input signal to the electromagnet displaces the weight. A vibration can be generated in the rotary unit under the action of the weight thus displaced. As a result, even if the rotary unit is rotating at all times, a vibration is generated at the moment when the weight is displaced as a result of the input signal being sent to the electromagnet. The vibration generator of the present invention can be mounted to a display device such as a tablet PC, a pen tablet, a game console or a navigation system. In this case, if an input signal is sent by performing an input operation on a display surface, a vibration is instantaneously generated in the rotary unit under rotation. It is therefore possible to rapidly generate a sensory vibration when an input operation is performed.

### BRIEF DESCRIPTION OF THE DRAWINGS

FIG. 1 is a vertical section view showing an internal structure of a vibration generator according to a first form of a first preferred embodiment of the present invention.

FIG. 2 is an exploded perspective view of the vibration generator shown in FIG. 1.

FIG. 3 is a perspective view the external appearance of the vibration generator.

FIG. 4 is an exploded perspective view showing a rotary unit with which a weight can make contact.

FIG. 5 is an exploded perspective view showing a weight mechanism unit.

FIG. 6 is an exploded perspective view showing an electromagnet for applying an electromagnetic force to a weight.

FIG. 7A is a partial section view illustrating a state in which the weight is biased toward the electromagnet and FIG. 7B is a partial section view illustrating a state in which the weight is brought into contact with the rotary unit.

FIG. 8 is a vertical section view showing an internal structure of a vibration generator according to a second form of the first preferred embodiment of the present invention.

FIG. 9 is an exploded perspective view showing a weight mechanism unit of the vibration generator shown in FIG. 8.

FIG. 10A is a partial section view illustrating a state in which the weight is biased toward the electromagnet and FIG. 10B is a partial section view illustrating a state in which the weight is brought into contact with the rotary unit.

FIG. 11 is a vertical section view showing an internal structure of a vibration generator according to a second preferred embodiment of the present invention.

FIG. 12 is an exploded perspective view of the vibration generator shown in FIG. 11.

FIG. 13A is a section view illustrating a state in which a movable weight is biased radially outward by a centrifugal force and FIG. 13B is a section view illustrating a state in which the movable weight is moved radially inward.

FIG. 14 is an explanatory view showing the arrangement of a weight when calculating acceleration by simulation.

### DESCRIPTION OF THE PREFERRED EMBODIMENTS

Certain preferred embodiments of the present invention will now be described with reference to the accompanying drawings. The technical scope of the present invention is not limited to the following description and the accompanying drawings.

(Basic Configuration)

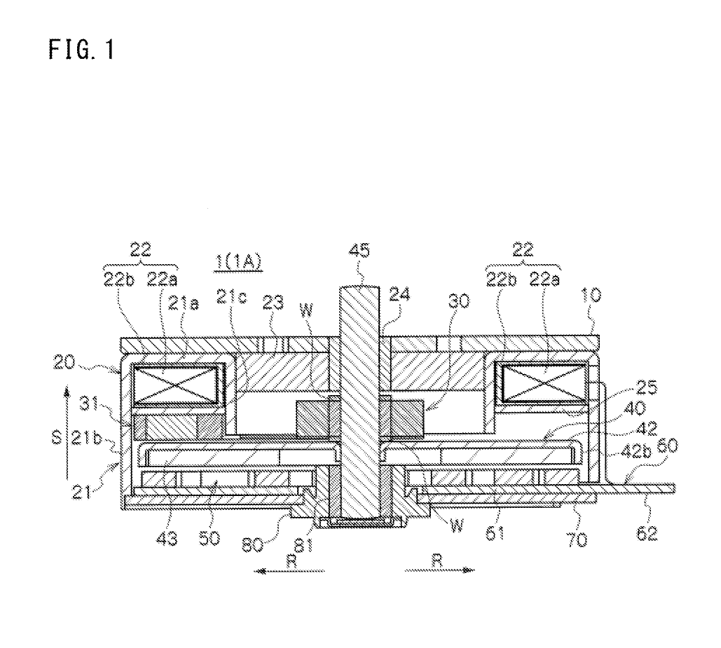

As shown in FIGS. 1, 8 and 11, a vibration generator 1 (1A, 1B or 1C) according to the present invention preferably includes at least a rotary unit 40 or 140, a weight 31, 31b or 130 for generating a vibration in the rotary unit 40 or 140 and an electromagnet 22 or 120 for displacing the weight 31, 31b or 130 to a position where a vibration is generated in the rotary unit 40 or 140. The vibration generator 1 is configured such that the electromagnet 22 or 120 displaces the weight 31, 31b or 130 with an electromagnetic force F1 or F3 generated by an input signal supplied to the electromagnet 22 or 120, thereby generating an eccentric load in the rotary unit 40 or 140.

In the vibration generator 1, the electromagnetic force F1 or F3 generated by an input signal supplied to the electromagnet 22 or 120 displaces the weight 31, 31b or 130 to a position where a vibration is generated in the rotary unit 40 or 140 under rotation. Under the action of the weight 31, 31b or 130 thus displaced, a vibration can be generated in the rotary unit 40 or 140. As a result, even if the rotary unit 40 or 140 is rotated at all times, a vibration is generated at the moment when the weight 31, 31b or 130 is displaced by an input signal sent to the electromagnet 22 or 120.

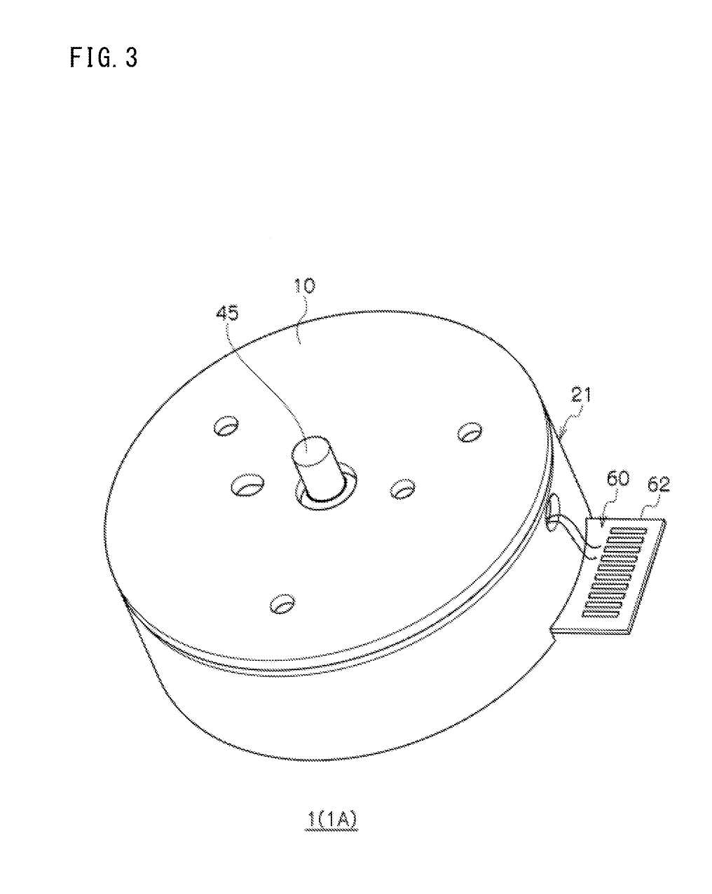

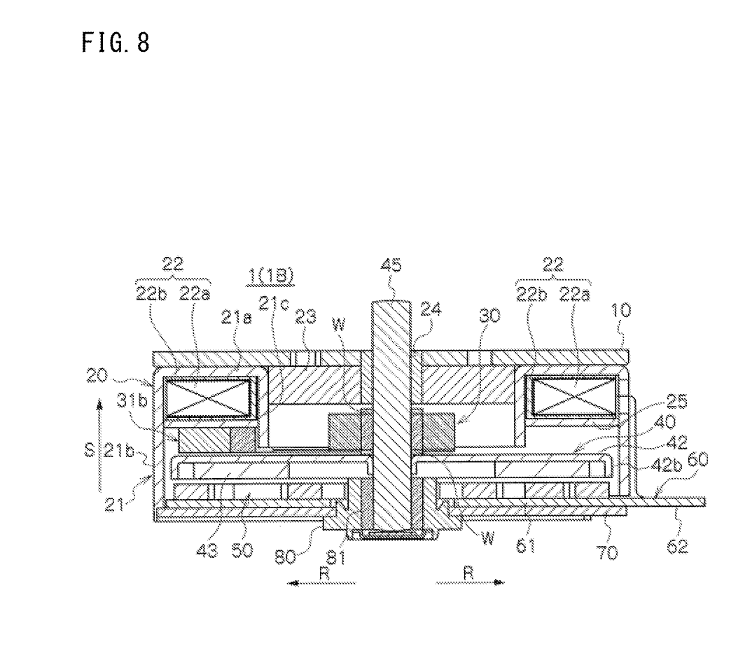

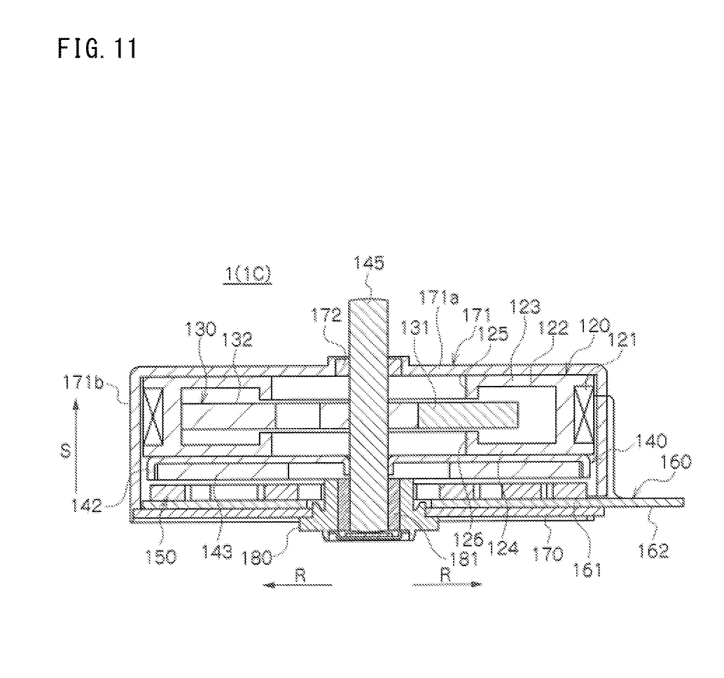

The vibration generator 1 of the present invention can be largely divided into the vibration generators 1A and 1B of the first preferred embodiment described in respect of FIGS. 1 through 10 and the vibration generator 1C of the second preferred embodiment described in respect of FIGS. 11 through 14. The vibration generators 1A and 1B of the first preferred embodiment include the vibration generator 1A of a first form shown in FIGS. 1 through 7 and the vibration generator 1B of a second form shown in FIGS. 8 through 10.

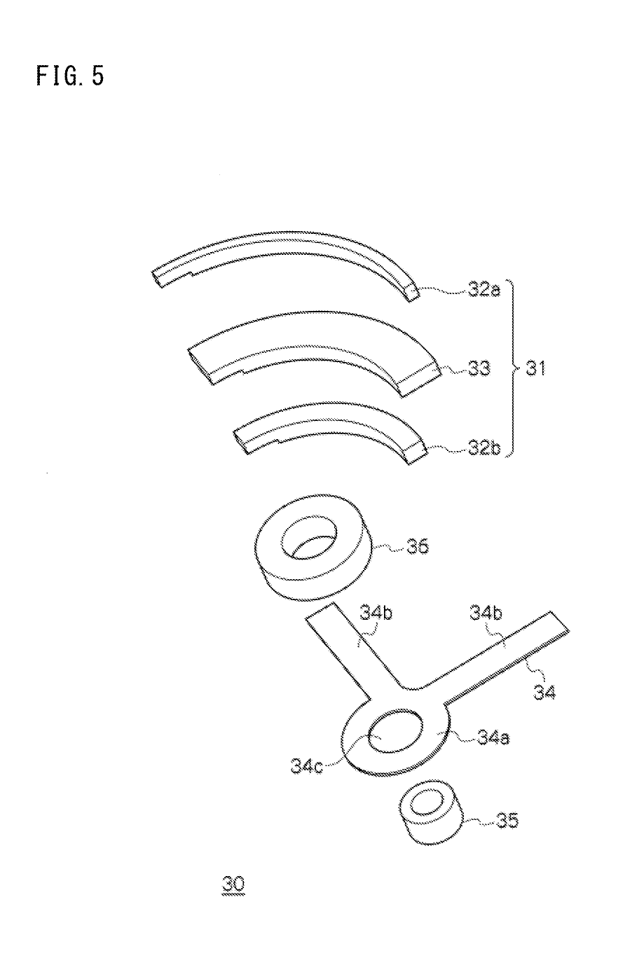

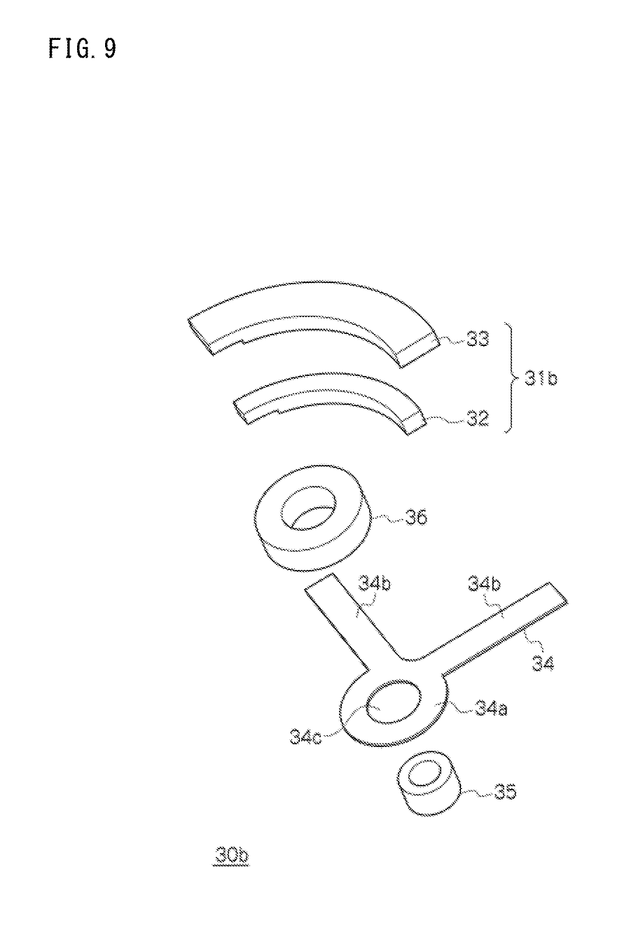

As shown in FIGS. 1 through 7 and FIGS. 8 through 10, the vibration generator 1A or 1B of the first preferred embodiment includes a rotary unit 40, a weight 31 or 31b and an electromagnet 22, which are non-unitarily arranged in a spaced-apart relationship in the named order along the thrust direction. The vibration generator 1A or 1B further includes a biasing unit 34 (see FIGS. 5 and 9) for biasing the weight 31 or 31b toward the electromagnet 22. Upon receiving an input signal, the electromagnet 22 displaces the weight 31 or 31b toward the rotary unit 40 with an electromagnetic force F1 stronger than a biasing force F2 of the biasing unit 34, thereby bringing the weight or 31b into contact with the rotary unit 40. Thus, before an input signal is sent to the electromagnet 22, the weight 31 or 31b is biased toward the electromagnet 22. After the input signal is sent to the electromagnet 22, the weight 31 or 31b is moved away from the electromagnet 22 and is displaced toward the rotary unit 40. The weight 31 or 31b displaced toward the rotary unit 40 under rotation destroys the weight balance of the rotary unit 40 and instantaneously generates a vibration using an eccentric load. By the term “non-unitarily”, it is meant that the weight 31 or 31b and the electromagnet 22 do not always follow the rotation and stoppage of the rotary unit 40.

As shown in FIGS. 11 through 14, the vibration generator 1C of the second preferred embodiment includes an electromagnet 120 and a weight 130 which are arranged along the radial direction. The electromagnet 120, the weight 130 and the rotary unit 140 are arranged in the thrust direction such that the electromagnet 120 and the weight 130 always follow the rotation and stoppage of the rotary unit 140. The weight 130 includes a movable weight 131 which is movable in the radial direction and a fixed weight 132 which is fixed in a specified radial position. Prior to an input signal being sent to the electromagnet 120, the movable weight 131 is moved radially outward by a centrifugal force F4 and is symmetrically arranged with respect to the fixed weight 132 about the center. Upon receiving an input signal, the electromagnet 120 displaces only the movable weight 131 radially inward. Thus, before the input signal is sent to the electromagnet 120, the movable weight 131 is displaced radially outward by the centrifugal force F4 of the rotary unit 140 under rotation. After the input signal is sent to the electromagnet 120, the movable weight 131 is displaced radially inward by the electromagnetic force F3. The radial inward movement of the movable weight 131 destroys the weight balance of the rotary unit 140 under rotation, instantaneously generating a vibration.

The respective preferred embodiments will now be described in order. In the following description, the term “radial direction” (indicated by symbol R) means a radius direction of the vibration generator 1A, 1B or 1C. The term “thrust direction” (indicated by symbol S) denotes a height direction of the vibration generator 1A, 1B or 1C.

### First Preferred Embodiment

### First Example

A vibration generator 1A according to a first example of a first preferred embodiment of the present invention has the same basic configuration as the vibration generator 1 described above. As shown in FIGS. 1 through 7, the vibration generator 1A preferably includes a rotary unit 40, a weight 31 and an electromagnet 22, which are non-unitarily arranged in a spaced-apart relationship in the named order along the thrust direction. The vibration generator 1A further includes a biasing unit 34 (see FIG. 5) for biasing the weight 31 toward the electromagnet 22 before an input signal is sent to the electromagnet 22. The biasing force F2 of the biasing unit 34 is weaker than the electromagnetic force F1 by which the weight 31 is displaced toward the rotary unit 40 after the input signal is sent to the electromagnet 22. Thus, before an input signal is sent to the electromagnet 22, the weight 31 is biased toward the electromagnet 22. After the input signal is sent to the electromagnet 22, the weight 31 is moved away from the electromagnet 22 and is displaced toward the rotary unit 40. The weight 31 displaced toward the rotary unit 40 under rotation destroys the weight balance of the rotary unit 40 and instantaneously generates a vibration. By the term “non-unitarily”, it is meant that the weight 31 and the electromagnet 22 do not always follow the rotation and stoppage of the rotary unit 40.

The respective components of the vibration generator 1A according to the first preferred embodiment of the present invention will now be described in more detail.

As shown in FIGS. 1 through 3, the vibration generator 1A of the first preferred embodiment has a cylindrical contour and preferably includes a base plate 70 defining a bottom surface, a case 21 capped on the base plate 70 and an attachment plate 10 arranged on the case 21.

The base plate 70 is a disc-shaped flat plate. The case 21 has a space defined in a radial center thereof, and preferably includes a doughnut-shaped top surface 21a, an outer wall surface 21b surrounding the periphery of the vibration generator 1A and an inner wall surface 21c joined to the inner circumferential edge of the top surface 21a and extending in the thrust direction. The thrust-direction dimension of the inner wall surface 21c is about one half of the thrust-direction dimension of the outer wall surface 21b. A space exists between the lower end of the inner wall surface 21c and the base plate 70. The attachment plate 10 is a member for use in attaching the vibration generator to a display device and is formed into a disc shape.

The respective components of the vibration generator 1A are arranged inside the base plate 70, the case 21 and the attachment plate 10. The components of the vibration generator 1A can be largely divided into: a rotary unit 40; a coil 50 and a substrate 60 serving as a drive unit for rotating the rotary unit 40; a weight mechanism unit 30 including a weight 31 capable of being brought into contact with or moved away from the rotary unit 40; and a magnetic path forming mechanism unit 20 arranged to form a magnetic path M for bringing the weight 31 into contact with the rotary unit 40 or moving the weight 31 away from the rotary unit 40.

The substrate 60 serving as a drive unit is attached to the upper surface of the base plate 70. The coil 50 serving as a drive unit is attached to the upper surface of the substrate 60.

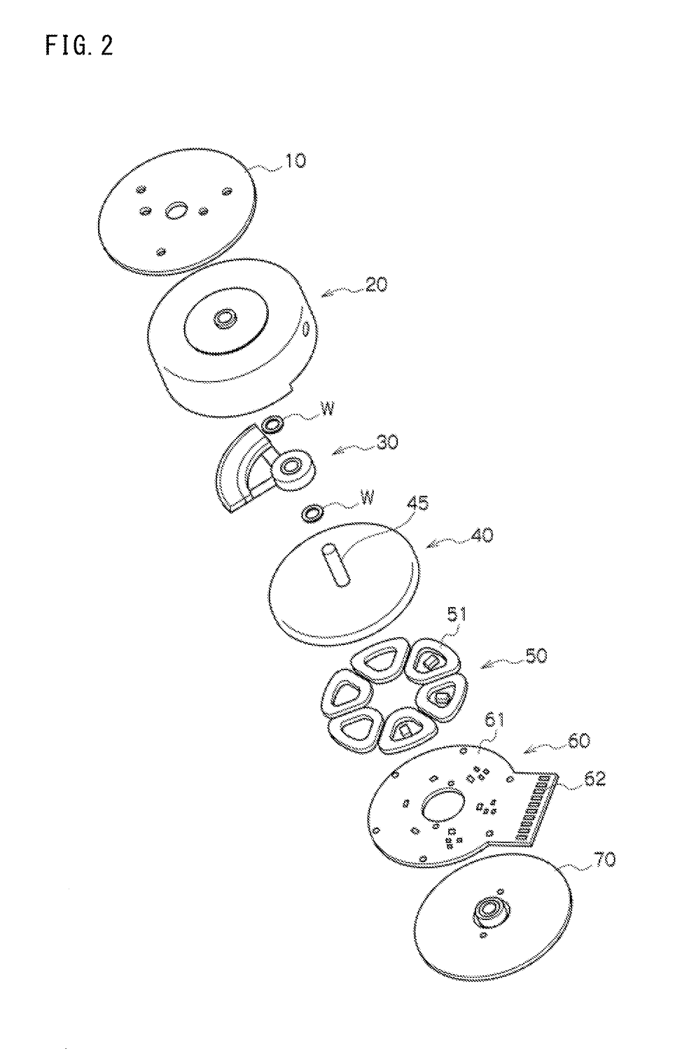

The substrate 60 preferably includes a disc-shaped body portion 61 arranged inside the case 21 and a connecting portion 62 protruding radially outward from the outer wall surface 21b of the case 21. As shown in FIG. 2, the coil 50 preferably includes a plurality of sector-like coil components 51 circularly arranged side by side. Each of the coil components 51 is formed by winding a wire along a sector-like contour.

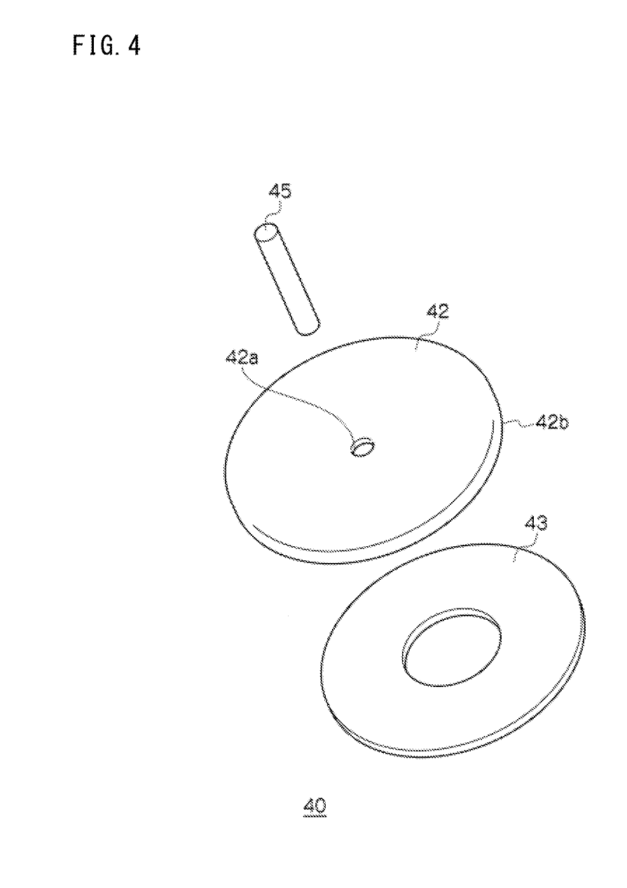

As shown in FIGS. 1 and 4, the rotary unit 40 preferably includes a rotor case 42 and a magnet 43 attached to the rotor case 42. The rotary unit 40 is fixed to a shaft 45 extending in the thrust direction at the center of the vibration generator 1A. The rotary unit 40 is configured to rotate together with the shaft 45 about the shaft 45.

The rotor case 42 is formed into a disc shape. The rotor case 42 has a hole 42a formed at the center thereof. The shaft 45 is inserted through the hole 42a of the rotor case 42. The rotor case 42 is fixed to the outer circumference of the shaft 45 in the position of the hole 42a. The rotor case 42 preferably includes a peripheral wall portion 42b bent downward from the outer peripheral edge of the rotor case 42.

The magnet 43 is formed into a doughnut shape. The magnet 43 is attached to the rear side of the rotor case 42 with the outer peripheral edge of the magnet 43 fitted to the inner side of the peripheral wall portion 42b of the rotor case 42. A circular space larger than the outer diameter of the shaft 45 is formed at the center of the magnet 43. Thus, a specified gap exists between the inner peripheral edge of the magnet 43 and the outer circumference of the shaft 45. For that reason, the magnet 43 is positioned relatively outward in the radial direction of the rotary unit 40. This structure of the rotary unit 40 helps increase the inertial force of the rotary unit 40 when the rotary unit 40 rotates together with the shaft 45.

One axial end of the shaft 45 is supported on a housing 80 attached to the base plate 70. The other axial end of the shaft 45 is rotatably supported by a bush 23 fitted inside the inner wall surface 21c of the case 21. The rotary unit 40 attached to the shaft 45 is horizontally arranged above the coil 50 with the rotor case 42 and the magnet 43 spaced apart by a specified gap from the coil 50. The substrate 60, the coil 50, the rotor case 42 and the magnet 43 are arranged in the space defined between the base plate 70 and the lower end of inner wall surface 21c of the case 21.

The housing 80 is inserted into a hole defined at the center of the base plate 70 and is attached to the base plate 70. The portion of the housing 80 positioned inside the base plate 70 is inserted into the hole of the substrate 60 and the central opening of the coil 50. The housing 80 has an axially extending through-hole defined at the center thereof. A metal-made bearing 81 is attached inside the through-hole of the housing 80. The bearing 81 has a cylindrical shape. The shaft 45 is inserted through the internal hole of the bearing 81. Thus, the bearing 81 rotatably supports one axial end of the shaft 45.

The bush 23 is a flat cylindrical member having a hole formed at the center thereof. The bush 23 covers the inner region of the inner wall surface 21c with the outer wall surface of the bush 23 fitted inside the inner wall surface 21c of the case 21. A metal-made bearing 24 is fitted to the center of the bush 23. The bearing 24 is a cylindrical member having a hole defined at the center thereof. The bearing 24 protrudes more upward than the upper surface of the bush 23. The upper portion of the bearing 24 is inserted into a hole defined at the center of the attachment plate 10 (see FIG. 1). The shaft 45 is inserted through the hole defined in the bearing 24 and is rotatably supported with respect to the bush 23 by the bearing 24.

As shown in FIG. 1, the weight mechanism unit 30 is arranged more upward than the rotary unit 40 in the thrust direction. As illustrated in FIG. 5, the weight mechanism unit 30 preferably includes a weight 31 arranged to make contact with the rotary unit 40 or to move away from the rotary unit 40 and a biasing unit 34 arranged to bias the weight 31 away from the rotary unit 40.

The weight 31 is formed to have an arc-shaped contour. The weight 31 preferably includes one non-magnetic portion 33 and two magnetic portions 32a and 32b. The magnetic portions 32a and 32b preferably includes a magnetic portion 32a arranged radially outward of the non-magnetic portion 33 and a magnetic portion 32b arranged radially inward of the non-magnetic portion 33.

The biasing unit 34 is a bifurcated spring made of a thin spring steel material. The biasing unit 34 preferably includes an annular attachment portion 34a and support portions 34b and 34b bifurcated from the attachment portion 34a so as to extend radially outward. One magnetic portion 32a, the non-magnetic portion 33 and the other magnetic portion 32b of the weight 31 are arranged on the tip ends of the support portions 34b and 34b in the named order from the radial outer side. The surfaces of the magnetic portion 32a, the non-magnetic portion 33 and the magnetic portion 32b facing the rotor case 42 of the rotary unit 40 are parallel to the upper surface of the rotor case 42.

The attachment portion 34a is attached to the shaft 45 through a metal-made bearing 35. The attachment portion 34a has a hole 34c defined at the center thereof. The biasing unit 34 and the bearing 35 are combined together by fitting the bearing 35 into the hole 34c of the attachment portion 34a. The attachment portion 34a may be attached to the thrust-direction lower portion of the bearing 35 (see FIG. 1). A bush 36 is fitted to the outer circumference of the bearing 35. While the bifurcated spring has been described as one example of the biasing unit 34, the biasing unit 34 is not limited to the bifurcated spring. Other springs having many different shapes may be used as the biasing unit 34 as long as the springs are capable of biasing the weight 31.

As shown in FIG. 1, the weight mechanism unit 30 is attached to the shaft 45 with a washer W interposed between the bearing 24 and the bearing 35. The weight mechanism unit 30 may be attached to the shaft 45 with a wash W interposed between the bearing 35 and the rotor case 42. Once the attachment portion 34a of the biasing unit 34 of the weight mechanism unit 30 is attached to the shaft 45, the weight 31 attached to the tip ends of the support portions 34b and 34b is arranged between the outer wall surface 21b and the inner wall surface 21c of the case 21. At this time, the washer W interposed between the bearing 35 and the rotor case 42 provides a gap between the rotary unit 40 and the weight 31.

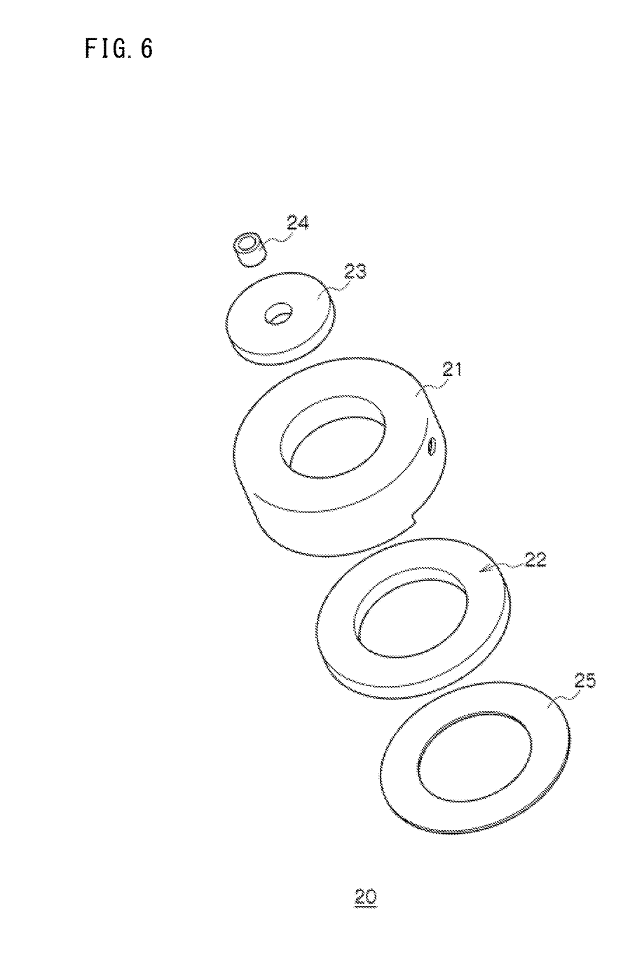

Referring to FIG. 6, the magnetic path forming mechanism unit 20 preferably includes a case 21, an electromagnet 22 formed of a coil 22a and a yoke 22b, and a partition plate 25. The coil 22a is formed by winding a wire into a doughnut shape. The yoke 22b is arranged to surround the coil 22a. The electromagnet 22 is accommodated within a region surrounded by the outer wall surface 21b, the top surface 21a and the inner wall surface 21c of the case 21 and the partition plate 25. The partition plate 25 is formed into a doughnut shape and is fitted between the outer wall surface 21b and the inner wall surface 21c of the case 21. The partition plate 25 prevents the electromagnet 22 from moving in the thrust direction.

The magnetic path forming mechanism unit 20 serves to form a magnetic path M in the inner wall surface 21c, the top surface 21a and the outer wall surface 21b of the case 21, the weight mechanism unit 30 and the rotary unit 40.

In the vibration generator 1A configured as above, the rotary unit 40, the weight 31 and the electromagnet 22 are non-unitarily arranged in a spaced-apart relationship in the named order along the thrust direction. By the term “non-unitarily”, it is meant that the weight 31 and the electromagnet 22 do not always follow the rotation and stoppage of the rotary unit 40. In the vibration generator 1A, if the display device provided with the vibration generator 1A is energized, the rotary unit 40 is rotated under the influence of the magnetic fields generated by the coil 50. The rotary unit 40 continues to rotate while the display device is energized.

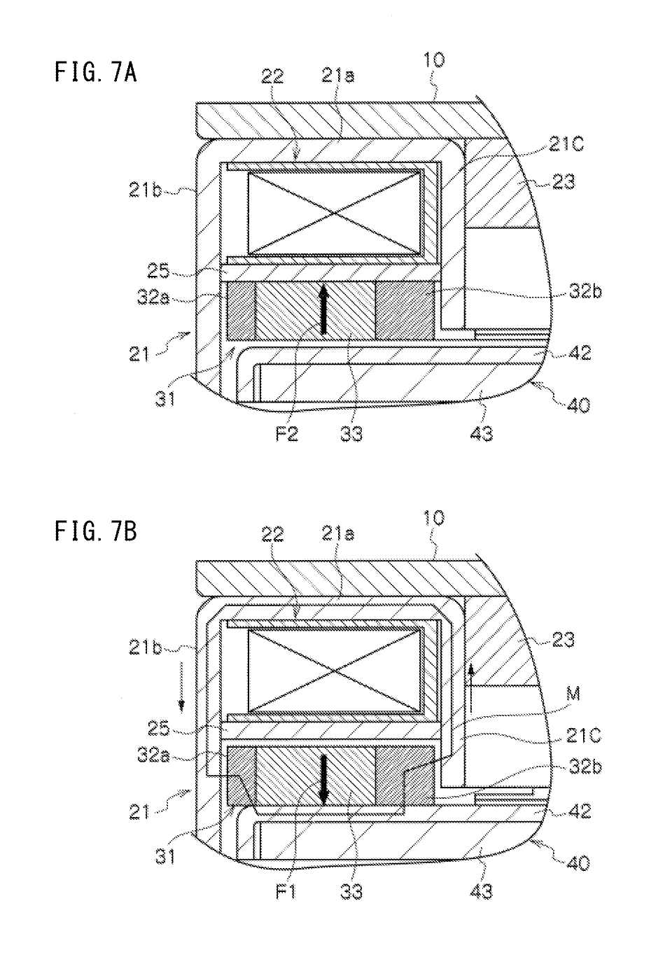

As shown in FIG. 7A, the weight 31 stays biased toward the electromagnet 22 by the biasing unit 34 before an input signal is sent to the electromagnet 22. For that reason, the weight 31 and the rotary unit 40 are spaced apart from each other. The partition plate 25 prevents the electromagnet 22 and the weight 31 from making contact with each other.

As shown in FIG. 7B, if an input signal is sent to the electromagnet 22 in this state, a magnetic path M is formed in the inner wall surface 21c, the top surface 21a and the outer wall surface 21b of the case 21, the weight 31 and the rotor case 42 of the rotary unit 40. The weight 31 is configured such that the non-magnetic portion 33 is radially interposed between the magnetic portions 32a and 32b. Thus, the magnetic portions 32a and 32b interposing the non-magnetic portion 33 therebetween become a portion of the magnetic path M and form the magnetic path M in cooperation with the electromagnet 22 and the rotary unit 40.

The magnetic path M formed in the outer wall surface 21b, the rotor case 42, the magnetic portions 32a and 32b and the inner wall surface 21c will be described in more detail.

In the region where the outer wall surface 21b and the magnetic portion 32a adjoin each other, the magnetic path M within the outer wall surface 21b is curved at a right angle to extend from the outer wall surface 21b toward the magnetic portion 32a. In the position between the outer wall surface 21b and the magnetic portion 32a, the magnetic path M is formed to build a bridge over the outer wall surface 21b and the magnetic portion 32a. The magnetic path M within the magnetic portion 32a is formed so as to interconnect the surface of the magnetic portion 32a facing the outer wall surface 21b and the surface of the magnetic portion 32a making contact with the rotor case 42. The magnetic path M communicates with the rotor case 42 on the surface of the magnetic portion 32a making contact with the rotor case 42. The magnetic path M within the rotor case 42 extends from the outer portion of the rotor case 42 to the portion of the rotor case 42 making contact with the magnetic portion 32b, through the portion of the rotor case 42 existing below the non-magnetic portion 33. In the region where the rotor case 42 and the magnetic portion 32b make contact with each other, the magnetic path M is curved from the rotor case 42 toward the magnetic portion 32b. In the region where the magnetic portion 32b and the inner wall surface 21c face each other, the magnetic path M is formed to build a bridge over the magnetic portion 32b and the inner wall surface 21c.

After an input signal is sent to the electromagnet 22, the electromagnetic force F1 for displacing the weight 31 toward the rotary unit 40 is stronger than the biasing force F2 of the biasing unit 34. Upon formation of the magnetic path M, the weight 31 is moved against the biasing force F2 of the biasing unit 34 and is moved toward the rotary unit 40. The weight 31 moved toward the rotary unit 40 is instantaneously brought into contact with the upper surface of the rotor case 42 making up the rotary unit 40. Since the weight 31 is instantaneously brought into contact with the upper surface of the rotor case 42, even if the rotary unit 40 is in a rotating condition, the weight 31 can rotate about the shaft 45 together with the rotary unit 40. As a result the weight 31 destroys the weight balance of the rotary unit 40 and momentarily applies an eccentric load to the rotary unit 40, whereby the rotary unit 40 becomes a vibration source.

If the input signal sent to the electromagnet 22 is cut off, the magnetic path M formed as above ceases to exist. Upon extinction of the magnetic path M, the contact force acting between the weight 31 and the rotary unit 40 becomes extinct. For that reason, the weight mechanism unit 30 is moved away from the rotor case 42 of the rotary unit 40 by the biasing force F2 of the biasing unit 34. As a result, no eccentric load is applied to the rotary unit 40 and no vibration is generated despite the rotation of the rotary unit 40.

Next, description will be made on a simulation result of a vibration generated by the vibration generator.

A simulation was carried out to find acceleration at revolution numbers of 6000 rpm, 7000 rpm and 8000 rpm under the assumption that the motor used has a weight of 73 g, the weight 31 has a weight of 18 g and the distance from the center of the shaft 45 to the gravity center of the weight 31 is 1.94 mm. The target value of the acceleration generated is 15 G or more.

As a result of the simulation, it was possible to obtain acceleration of 13.63 G at the revolution number of 6000 rpm, acceleration of 18.56 G at the revolution number of 7000 rpm and acceleration of 24.24 G at the revolution number of 8000 rpm.

### Second Example

A vibration generator 1B according to a second example of the first preferred embodiment has substantially the same basic configuration as that of the vibration generator 1A of the first form. The vibration generator 1B differs from the vibration generator 1A in that the weight 31b of the vibration generator 1B does not include an outer magnetic portion. Therefore, the same components of the vibration generator 1B of the second form as those of the vibration generator 1A of the first form will be designated by like reference symbols and will be described briefly. Detailed description will be made on only the components of the vibration generator 1B of the second form differing from the components of the vibration generator 1A of the first form.

As shown in FIGS. 8 and 9, the vibration generator 1B of the second form has a cylindrical contour and preferably includes a disc-shaped base plate 70 defining a bottom surface, a case 21 capped on the base plate 70 and a disc-shaped attachment plate 10 arranged on the case 21. The vibration generator 1B further includes a rotary unit 40, a coil 50 and a substrate 60 arranged to rotate the rotary unit 40, a weight mechanism unit 30b having a weight 31b arranged to make contact with the rotary unit 40 or to move away from the rotary unit 40, and a magnetic path forming mechanism unit 20 having an electromagnet 22 arranged to form a magnetic path M, all of which are arranged inside the base plate 70, the case 21 and the attachment plate 10. The rotary unit 40, the weight 31b and the electromagnet 22 are non-unitarily arranged in a spaced-apart relationship in the named order along the thrust direction. By the term “non-unitarily”, it is meant that, as in the vibration generator 1A, the weight 31b and the electromagnet 22 do not always follow the rotation and stoppage of the rotary unit 40.

As shown in FIGS. 8 and 9, the weight mechanism unit 30b is arranged above the rotary unit 40 in the thrust direction. The weight mechanism unit 30b preferably includes a weight 31b arranged to make contact with the rotary unit 40 or to move away from the rotary unit 40 and a biasing unit 34 arranged to bias the weight 31b away from the rotary unit 40. The weight 31b is formed to have an arc-shaped contour. The weight 31b preferably includes only two parts, i.e., a non-magnetic portion 33 and a magnetic portion 32 arranged radially inward of the non-magnetic portion 33.

The biasing unit 34 preferably includes an annular attachment portion 34a and support portions 34b and 34b bifurcated from the attachment portion 34a so as to extend radially outward. The non-magnetic portion 33 and the magnetic portion 32 of the weight 31b are attached to the tip ends of the support portions 34b and 34b in the named order from the radial outer side. The surfaces of the magnetic portion 32 and the non-magnetic portion 33 facing the rotor case 42 of the rotary unit 40 are parallel to the upper surface of the rotor case 42.

The biasing unit 34 and the bearing 35 are combined together by fitting the bearing 35 into the hole 34c of the attachment portion 34a. A bush 36 is fitted to the outer circumference of the bearing 35. The biasing unit 34 is not limited to the bifurcated spring. Other springs having many different shapes may be used as the biasing unit 34 as long as the springs are capable of biasing the weight.

In the vibration generator 1B of the second form, the weight 31b includes the non-magnetic portion 33 and only one magnetic portion 32 arranged radially inward of the non-magnetic portion 33. This makes it possible to manufacture the vibration generator 1B with a smaller number of parts than in the vibration generator 1A of the first form. It is therefore possible to reduce the price of the product. The reduction in the number of parts leads to a decrease in the assembling steps. This makes it possible to reduce the manufacturing cost.

As shown in FIGS. 8 and 9, the weight mechanism unit 30b is attached to the shaft 45 with washers W interposed between the bearing 24 and the bearing 35 and between the bearing 35 and the rotor case 42.

Just like the magnetic path forming mechanism unit 20 of the vibration generator 1A, the magnetic path forming mechanism unit 20 of the vibration generator 1B preferably includes a case 21, a electromagnet 22 formed of a coil 22a and a yoke 22b, and a partition plate 25 (see FIG. 6). The magnetic path forming mechanism unit 20 is arranged to form a magnetic path M in the inner wall surface 21c, the top surface 21a and the outer wall surface 21b of the case 21, the weight mechanism unit 30b and the rotary unit 40.

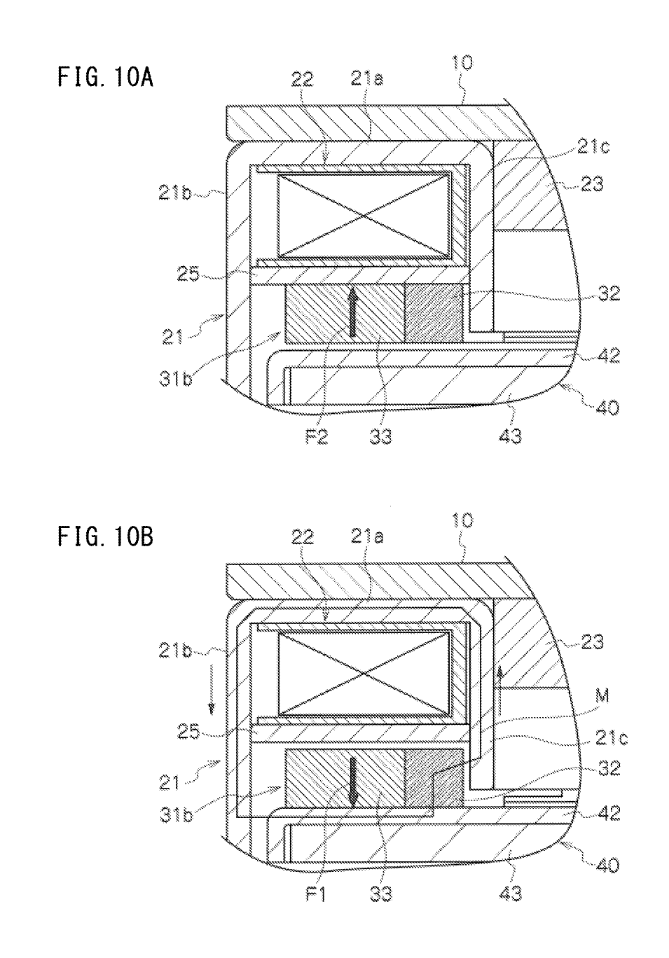

In the vibration generator 1B configured as above, as shown in FIG. 10A, the weight 31b is biased toward the electromagnet 22 by the biasing unit 34 before an input signal is sent to the electromagnet 22. Thus, the weight 31b stays spaced apart from the rotary unit 40. The partition plate 25 prevents the electromagnet 22 and the weight 31b from making contact with each other. This operation is the same as the operation of the vibration generator 1A.

As shown in FIG. 10B, if an input signal is sent to the electromagnet 22 in this state, a magnetic path M is formed in the inner wall surface 21c, the top surface 21a and the outer wall surface 21b of the case 21, the weight 31b and the rotor case 42 of the rotary unit 40. In the weight 31b, the magnetic portion 32 is arranged radially inward of the non-magnetic portion 33. Therefore, the magnetic portion 32 becomes a portion of the magnetic path M. The electromagnet 22 forms a magnetic path M in cooperation with the rotary unit 40.

The magnetic path M formed in the outer wall surface 21b, the rotor case 42, the magnetic portion 32 and the inner wall surface 21c will be described in more detail.

In the region where the outer wall surface 21b and the rotor case 42 adjoin each other, the magnetic path M within the outer wall surface 21b is curved at a right angle to extend from the outer wall surface 21b toward the magnetic portion 32. In the position between the outer wall surface 21b and the rotor case 42, the magnetic path M is formed to build a bridge over the outer wall surface 21b and the rotor case 42. The magnetic path M within the rotor case 42 extends from the outer portion of the rotor case 42 to the portion of the rotor case 42 making contact with the magnetic portion 32, through the portion of the rotor case existing below the non-magnetic portion 33. In the region where the rotor case 42 and the magnetic portion 32 make contact with each other, the magnetic path M is curved from the rotor case 42 toward the magnetic portion 32. In the region where the magnetic portion 32 and the inner wall surface 21c face each other, the magnetic path M is formed to build a bridge over the magnetic portion 32 and the inner wall surface 21c.

After an input signal is sent to the electromagnet 22, the electromagnetic force F1 for displacing the weight 31b toward the rotary unit 40 is stronger than the biasing force F2 of the biasing unit 34. Upon formation of the magnetic path M, the weight 31b is moved against the biasing force F2 of the biasing unit 34 and is moved toward the rotary unit 40. The weight 31b moved toward the rotary unit 40 is instantaneously brought into contact with the upper surface of the rotor case 42 making up the rotary unit 40. Since the weight 31b is instantaneously brought into contact with the upper surface of the rotor case 42, even if the rotary unit 40 is in a rotating condition, the weight 31b can rotate about the shaft 45 together with the rotary unit 40. As a result the weight 31b destroys the weight balance of the rotary unit 40 and momentarily applies an eccentric load to the rotary unit 40, whereby the rotary unit 40 becomes a vibration source.

If the input signal sent to the electromagnet 22 is cut off, the magnetic path M formed as above ceases to exist. Upon extinction of the magnetic path M, the contact force acting between the weight 31b and the rotary unit 40 becomes extinct. For that reason, the weight mechanism unit 30b is moved away from the rotor case 42 of the rotary unit 40 by the biasing force F2 of the biasing unit 34. As a result, no eccentric load is applied to the rotary unit 40 and no vibration is generated despite the rotation of the rotary unit 40.

Even if the weight 31b is formed of the non-magnetic portion 33 and the magnetic portion 32 arranged radially inward of the non-magnetic portion 33, there is no problem in moving the weight 31b toward the rotor case 42 of the rotary unit 40. With this configuration, the weight 31b becomes lightweight. It is therefore possible to shorten the time required in moving the weight 31b to the rotary unit 40 to convert the state shown in FIG. 10A to the state shown in FIG. 10B. Similarly, it is possible to shorten the time required in moving the weight 31b away from the rotary unit 40 to convert the state shown in FIG. 10B to the state shown in FIG. 10A. In this manner, the movement response characteristic of the weight 31b can be improved by making the weight 31b lightweight.

In the weight 31b described above, the radial dimension of the non-magnetic portion 33 is set such that a relatively large gap is formed between the outer wall surface 21b of the case 21 and the peripheral edge of the rotor case 42 making up the rotary unit 40. Alternatively, the radial dimension of the non-magnetic portion 33 of the weight 31b may be set such that a small gap is formed between the outer wall surface 21b of the case 21 and the peripheral edge of the rotor case 42 making up the rotary unit 40. For example, the radial dimension of the non-magnetic portion 33 may be set such that the outer peripheral edge of the non-magnetic portion 33 is arranged in the same position or substantially in the same position as the outer peripheral edge of the magnetic portion 32a of the weight 31 of the vibration generator 1A. If the radial dimension of the non-magnetic portion 33 is set in this manner, the weight of the weight 31b grows larger. This makes it possible to provide an effect of increasing the magnitude of vibration.

### Second Preferred Embodiment

The respective components of a vibration generator 1C according to a second preferred embodiment of the present invention will be described in detail with reference to FIGS. 11 through 14.

In the second preferred embodiment, as shown in FIGS. 11 through 14, the electromagnet 120 and the weight 130 are arranged along the radial direction. The electromagnet 120, the weight 130 and the rotary unit 140 are arranged along the thrust direction so that the electromagnet 120 and the weight 130 can always follow the rotation and stoppage of the rotary unit 140. The weight 130 preferably includes a movable weight 131 capable of being moved radially outward by a centrifugal force F4 before an input signal is sent to the electromagnet 120 and a fixed weight 132 symmetrically arranged with respect to the movable weight 131. The electromagnet 120 is configured to move only the movable weight 131 radially inward after an input signal is sent to the electromagnet 120. Therefore, before an input signal is sent to the electromagnet 120, the movable weight 131 is moved radially outward by the centrifugal force F4 of the rotary unit 140 under rotation. After an input signal is sent to the electromagnet 120, the movable weight 131 is moved radially inward by the electromagnetic force F3. When moved radially inward, the movable weight 131 destroys the weight balance of the rotary unit 140 under rotation and momentarily generates a vibration.

Detailed description will now be made on the respective components of the vibration generator according to the second preferred embodiment.

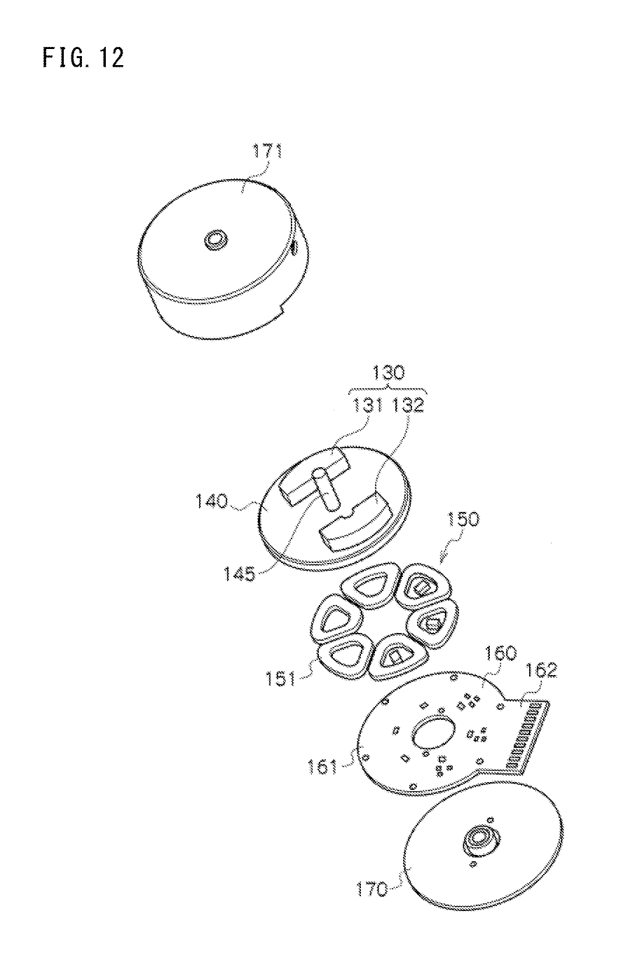

As shown in FIGS. 11 and 12, the vibration generator 1C of the second preferred embodiment is formed to have a cylindrical contour. The vibration generator 1C preferably includes a base plate 170 defining a bottom surface and a case 171 capped on the base plate 170.

The base plate 170 is a disc-shaped flat plate. The case 171 preferably includes a circular top surface 171a and an outer wall surface 171b surrounding the periphery of the vibration generator 1C.

The respective components of the vibration generator 1C are arranged inside the base plate 170 and the case 171. The components of the vibration generator 1C can be divided into a rotary unit 140, a coil 150 and a substrate 160 serving as a drive unit for rotating the rotary unit 140, a weight 130 for applying an eccentric load to the rotary unit 140 as the rotary unit 140 makes rotation and an electromagnet 120 arranged to form a magnetic path M for displacing the weight 130.

The substrate 160 serving as the drive unit is attached to the upper surface of the base plate 170. The coil 150 serving as the drive unit is attached to the upper surface of the substrate 160.

The substrate 160 preferably includes a disc-shaped body portion 161 arranged inside the case 171 and a connecting portion 162 protruding radially outward from the outer wall surface 171b of the case 171. The coil 150 preferably includes a plurality of sector-like coil components 151 circularly arranged side by side. Each of the coil components 151 is formed by winding a wire along a sector-like contour.

The rotary unit 140 preferably includes a rotor case 142 and a magnet 143 attached to the rotor case 142. The rotary unit 140 is fixed to a shaft 145 extending in the thrust direction at the center of the vibration generator 1C. The rotary unit 140 is configured to rotate together with the shaft 145 about the shaft 145.

The rotor case 142 is formed into a disc shape. The shaft 145 is inserted through the center of the rotor case 142, whereby the shaft 145 and the rotor case 142 are combined together.

The magnet 143 is formed into a doughnut shape. The magnet 143 is attached to the rear side of the rotor case 142. A circular space larger than the outer diameter of the shaft 145 is formed at the center of the magnet 143. Thus, a specified gap is defined between the inner peripheral edge of the magnet 143 and the outer circumference of the shaft 145.

One axial end of the shaft 145 is supported on a housing 180 attached to the base plate 170. The other axial end of the shaft 145 is rotatably supported by a bearing 172 attached to the top surface 171a of the case 171.

The housing 180 is inserted into a hole defined at the center of the base plate 170 and is attached to the base plate 170. The portion of the housing 180 positioned inside the base plate 170 is inserted into the hole of the substrate 160 and the central opening of the coil 150. The housing 180 has an axially extending through-hole defined at the center thereof. A metal-made bearing 181 is attached inside the through-hole of the housing 180. The shaft 145 is inserted through the internal hole of the bearing 181. Thus, the bearing 181 rotatably supports one axial end of the shaft 145.

A metal-made bearing 172 is attached to the top surface 171a of the case 171. The bearing 172 is attached to the center of the top surface 171a. The bearing 172 is a flat cylindrical member having a hole defined at the center thereof. The shaft 145 is inserted through the hole of the bearing 172 and is supported by the bearing 172 to rotate with respect to the case 171.

The electromagnet 120 preferably includes a coil 121 and a yoke 122. The coil 121 is formed by winding a wire into a doughnut shape. The coil 121 is arranged above the rotary unit 140 to extend along the inside of the outer wall surface 171b of the case 171. The yoke 122 is arranged radially inward of the coil 121. The yoke 122 is formed to have a doughnut-shaped contour. The yoke 122 holds the coil 121 on the outer circumference thereof. The yoke 122 preferably includes magnetic path forming portions 123 and 124 protruding radially inward in the thrust-direction upper and lower portions thereof. The radial inner ends of the magnetic path forming portions 123 and 124 are bent to face each other, thus forming inner circumferential portions 125 and 126. A space exists between the tip ends of the inner circumferential portions 125 and 126. The electromagnet 120 serves to form a magnetic path M in the yoke 122 and the weight 130.

The weight 130 is arranged radially inward of the electromagnet 120 in the space defined between the tip ends of the inner circumferential portions 125 and 126. The weight 130 is configured to rotate together with the shaft 145. The weight 130 preferably includes a movable weight 131 capable of moving in the radial direction and a fixed weight 132 arranged at the opposite side of the shaft 145 from the movable weight 131.

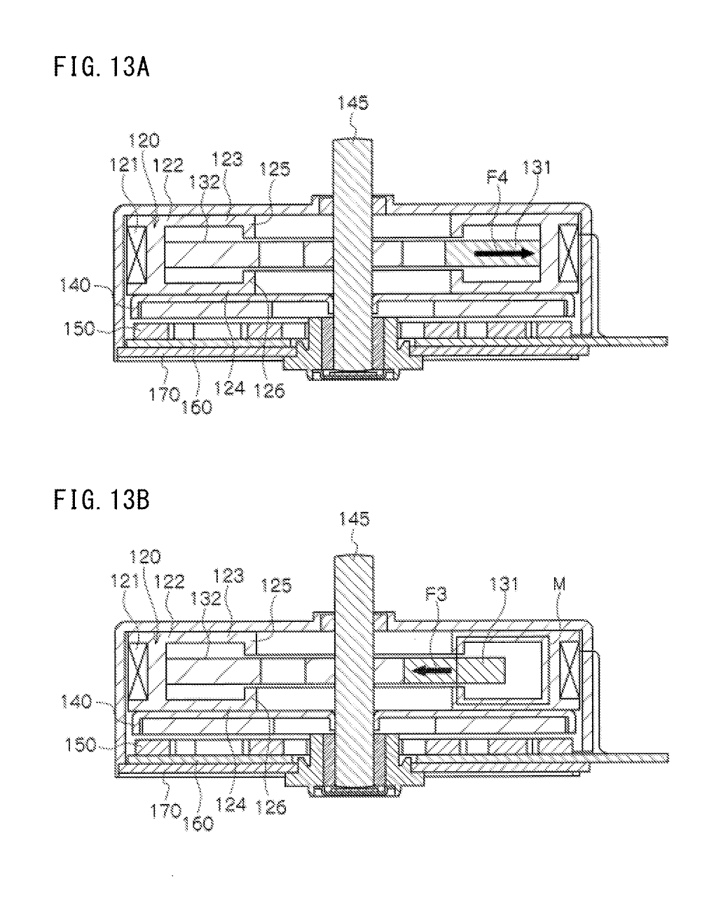

The fixed weight 132 is radially spaced apart by a specified distance from the shaft 145. As shown in FIGS. 11 and 13, the fixed weight 132 is arranged in the same radial position as the magnetic path forming portions 123 and 124 of the yoke 122.

The movable weight 131 is configured to radially move between a position where the magnetic path forming portions 123 and 124 are arranged and a position existing radially inward of the magnetic path forming portions 123 and 124. The movable weight 131 preferably includes a magnetic portion and non-magnetic portions, the magnetic portion arranged to generate a magnetic path M in the electromagnet 120 and the movable weight 131 as an input signal is sent to the electromagnet 120. The magnetic portion is arranged at the center of the movable weight 131. Thus, the magnetic portion becomes a portion of the magnetic path M and forms the magnetic path M in cooperation with the electromagnet 120. As a result, if an input signal is sent to the electromagnet 120, the movable weight 131 is moved radially inward against the centrifugal force F4 under the action of the magnetic path M. Consequently, the movable weight 131 destroys the weight balance of the rotary unit 140 and applies an eccentric load to the rotary unit 140, thus momentarily generating a vibration.

In the vibration generator 1C configured as above, if the display device provided with the vibration generator 1C is energized, the rotary unit 140 is rotated under the influence of the magnetic fields generated by the coil 150. The weight 130 is also rotated along with the rotation of the rotary unit 140. The rotary unit 140 continues to rotate while the display device is energized.

As shown in FIG. 13A, before an input signal is sent to the electromagnet 120, the movable weight 131 is kept by a centrifugal force in the region where the magnetic path forming portions 123 and 124 are arranged. Prior to the input signal being sent to the electromagnet 120, the movable weight 131 and the fixed weight 132 are symmetrically arranged with respect to the shaft 145. For that reason, the weight 130 rotates in a balanced manner.

As shown in FIG. 13B, if an input signal is sent to the electromagnet 120 in this state, a magnetic path M is formed in the yoke 122 and the movable weight 131. In the movable weight 131, the magnetic portion interposed between the non-magnetic portions become a portion of the magnetic path M and form the magnetic path M in cooperation with the electromagnet 120. After an input signal is sent to the electromagnet 120, the electromagnetic force F3 acting to displace the movable weight 131 radially inward is stronger than the centrifugal force F4 applied to the movable weight 131. Therefore, upon formation of the magnetic path M, the movable weight 131 is instantaneously moved radially inward against the centrifugal force F4. As a result, even when the rotary unit 140 is in a rotating condition, the weight 130 destroys the weight balance of the rotary unit 140 and applies an eccentric load to the rotary unit 140, thereby instantaneously generating a vibration.

If the input signal sent to the electromagnet 120 is cut off, the magnetic path M formed as above ceases to exist. Upon extinction of the magnetic path M, the movable weight 131 is moved radially outward by the centrifugal force F4. As a result, the movable weight 131 and the fixed weight 132 become symmetrical with respect to the shaft 145 again. If the movable weight 131 and the fixed weight 132 are symmetrically arranged with respect to the shaft 145, no eccentric load is applied to the rotary unit 140 and no vibration is generated in the rotary unit 40.

Next, description will be made on a simulation result of a vibration generated by the vibration generator.

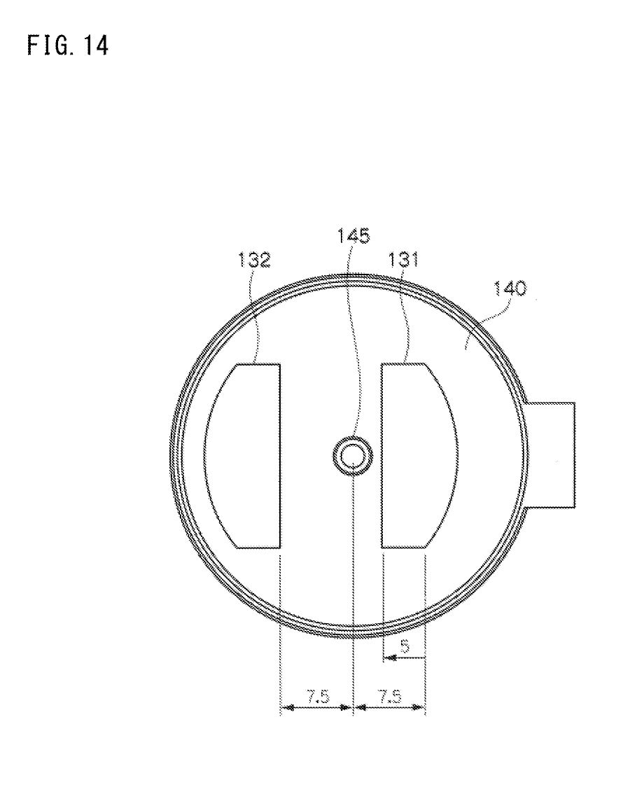

Referring to FIG. 14, a simulation was carried out to find acceleration generated when the movable weight 131 is moved 5 mm toward the center of the vibration generator from the position spaced apart 7.5 mm from the center of the vibration generator, in which position the movable weight 131 and the fixed weight 132 are kept balanced. In the event that the weight of each of the movable weight 131 and the fixed weight 132 is 4.44 g, the distance from the center of vibration generator to the gravity center of each of the movable weight 131 and the fixed weight 132 is 10.94 mm and the revolution number is 628.3 rad/s, the centrifugal force acting on each of the movable weight 131 and the fixed weight 132 is 2.0 kgf (19.6 N, where 1 kgf is equal to 9.8 N). The target value of the acceleration generated is 15 G or more.

As a result of the simulation, it was possible to obtain acceleration of 15.8 G which is larger than the target value, 15 G.

The vibration generator 1A, 1B or 1C of the present invention described above can be mounted to a display device such as a tablet PC, a pen tablet, a game console or a navigation system. In this case, if an input signal is sent by performing an input operation on a display surface, a vibration is instantaneously generated in the rotary unit 40 or 140 under rotation. It is therefore possible to rapidly generate a sensory vibration when an input operation is performed. While the rotary unit 40 or 140 rotates at all time in the first and second preferred embodiments, the rotation of the rotary unit 40 or 140 may be stopped, if appropriate.

What is claimed is:

1. A vibration generator, comprising:
a rotary unit configured to rotate;
a weight arranged to generate a vibration in the rotary unit; and
an electromagnet arranged to displace the weight to a position where a vibration is generated in the rotary unit,
wherein the electromagnet is configured to generate an eccentric load in the rotary unit by displacing the weight with an electromagnetic force generated when an input signal is sent to the electromagnet.

2. The vibration generator of claim 1, wherein the rotary unit, the weight and the electromagnet are separately arranged along a thrust direction in the named order, the weight kept biased toward the electromagnet by a biasing unit, the electromagnet configured to, upon receiving the input signal, displace the weight toward the rotary unit with an electromagnetic force stronger than a biasing force of the biasing unit and bring the weight into contact with the rotary unit.

3. The vibration generator of claim 2, wherein the weight includes magnetic portions and a non-magnetic portion, the magnetic portions arranged to generate a magnetic path in the electromagnet, the weight and the rotary unit when the input signal is sent to the electromagnet, the magnetic portions configured to radially interpose the non-magnetic portion therebetween.

4. The vibration generator of claim 2, wherein the weight includes a magnetic portion and a non-magnetic portion, the magnetic portion arranged to generate a magnetic path in the electromagnet, the weight and the rotary unit when the input signal is sent to the electromagnet, the magnetic portion arranged radially inward of the non-magnetic portion.

5. The vibration generator of claim 1, wherein the electromagnet and the weight are arranged along a radial direction, the weight including a movable weight capable of moving in the radial direction and a fixed weight arranged opposite to the movable weight with respect to the center of the rotary unit, the electromagnet configured to, upon receiving the input signal, generate an electromagnetic force for displacing the movable weight radially inward against a centrifugal force generated by rotation of the weight.

6. The vibration generator of claim 5, wherein the movable weight includes a magnetic portion and non-magnetic portions, the magnetic portion arranged to generate a magnetic path in the electromagnet and the movable weight when the input signal is sent to the electromagnet, the magnetic portion arranged at the center of the movable weight.
